(19) United States
(12) Patent Application Publication
(10) Pub. No.: US 2007/0042263 A1
(43) Pub. Date: Feb. 22, 2007

(54) Single cell module system

(76) Inventor: Gary M. Balash, Blandon, PA (US)

Correspondence Address: ZACHARY T. WOBENSMITH, III, 7746 101st Court, Vero Beach, FL, 32967-2871, US

(21) Appl. No.: 11/205,335

(22) Filed: Aug. 18, 2005

(51) Int. Cl. H01M 2/10; B65D 85/00

(52) U.S. Cl. 429/99; 429/100; 206/703

(57) ABSTRACT

A single cell module system, which has a mounting, base a module attached to the base, and at least one sleeve which fits into the module and receives a battery cell, with the modules stackable on the base.

### FIELD OF THE INVENTION

This invention relates to a single cell module system for lead-acid batteries, which system protects the cell during handling, permitting the cell to be installed or removed from the module without contacting the cell.

### DESCRIPTION OF THE PRIOR ART

In the prior art, it has been known to provide modular cell tray assemblies, which contain a plurality of cells, which are connected together to form batteries for use as stand by, or uninterruptible power supplies, for use by computer systems, or for other applications where uninterruptible power supplies are required. Such systems typically use a plurality of sealed lead-acid cells, which cells are connected together in series, or parallel, to form batteries, which provide the power source.

Such assemblies are known in the art, such as shown in the U.S. Patent to Sherwood, No. U.S. Pat. No. 6,451,475 B1, which has a base with a plurality of cell tray assemblies thereon. While this structure is satisfactory, the cells are carried directly in the module and are not protected during installation and removal.

Lead-acid cells are the cells of choice, and as the requirements for higher capacity cells has increased, the weight of the cell designs has increased, with weights reaching 200 to 300 lbs.

One of the concerns arising from battery cell system installation, is that the installers often remove the cells from the module in order to reduce the weight, with the installers pulling the cells from the module by their posts. This practice can lead to stress on the posts, which can lead to acid leaks through the post, or damage to the cover leading to premature failure of the cell.

These systems are typically used in the communications industry, which requires uninterruptible power. The heavy weight requires that the system be capable of withstanding high seismic conditions, such as Nebs zone 4 seismic requirements, often requiring external bracing.

The single cell module system of the invention provides protection for the battery cells during installation and removal, with a small footprint, and which meets Nebs zone 4 seismic requirements without the use of external brace kits.

### SUMMARY OF THE INVENTION

A single cell module system, which consists of a mounting base, which can be fastened to the floor, a module to be fastened to the base to receive two single cell sleeves, which hold the battery cells, and which sleeves have buttons to space the cells, and to strengthen the sleeves and permit air flow, with flanges on the sleeves for mounting to the module.

The principal object of the invention is to provide a single cell module system that consists of a base, a module to mount to the base, and at least one cell sleeve carried in the module to hold a battery cell.

A further object of the invention is to provide a system that is simple and inexpensive to construct, but sturdy and reliable in use.

A further object of the invention is to provide a system that has a small footprint.

A further object of the invention is to provide a system that meets Nebs zone 4 seismic requirements. a further object of the invention is to provide a system in which the modules can be stacked.

A further object of the invention is to provide a system, which provides good airflow for cooling the battery cells.

Other objects and advantageous features of the invention will be apparent from the description and claims.

### DESCRIPTION OF THE DRAWINGS

The nature and characteristic features of the invention will be more readily understood from the following description taken in connection with the accompanying drawings forming part hereof in which,

FIG. 1 is a perspective view of a cell sleeve of the invention;

FIG. 1A is an exploded view of the cell sleeve of FIG. 1;

FIG. 2 is a view similar to FIG. 1 with a battery cell carried in the sleeve;

FIG. 3 is a perspective view of the module of the invention;

FIG. 3A is an exploded view of the module of FIG. 3;

FIG. 4 is a perspective view of the mounting base of the invention;

FIG. 4A is an exploded view of the mounting base of the invention;

FIG. 5 is an exploded perspective view of the single cell module system of the invention;

FIG. 6 is a perspective view of the single cell module system of the invention in assembled condition, and

FIG. 7 is a perspective view of the single cell module system with a plurality of stacked modules.

It should, of course, be understood that the description and drawings herein are merely illustrative, and that various modifications and changes can be made in the structures, and embodiments disclosed without departing from the spirit of the invention.

### DESCRIPTION OF THE PREFERRED EMBODIMENT

When referring to the preferred embodiment, certain terminology will be utilized for the sake of clarity. Use of such terminology is intended to encompass not only the described embodiment, but also technical equivalents, which operate and function in substantially the same way to bring about the same result.

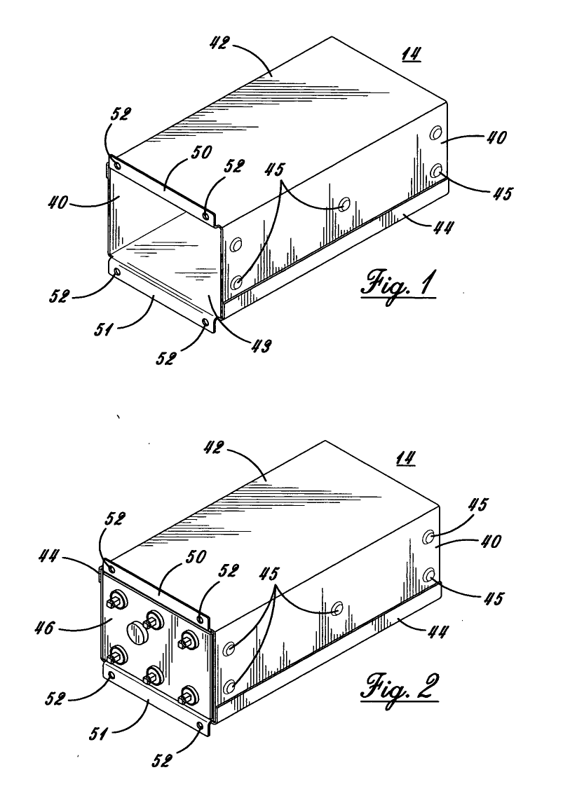

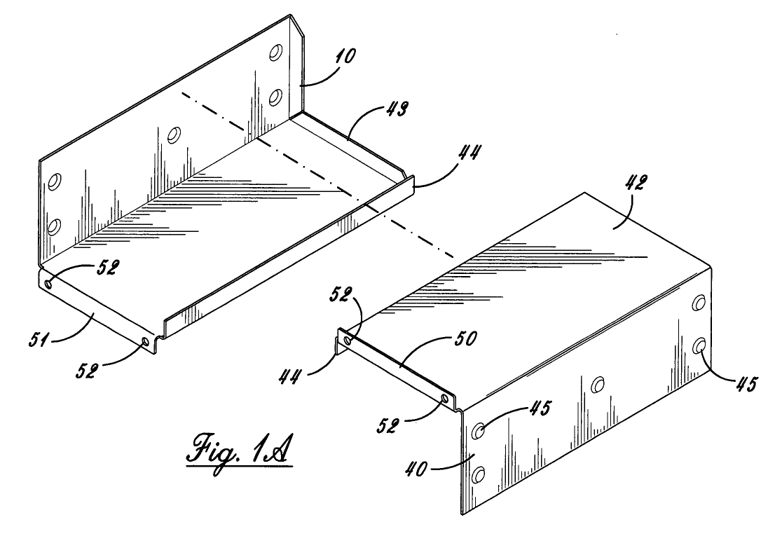

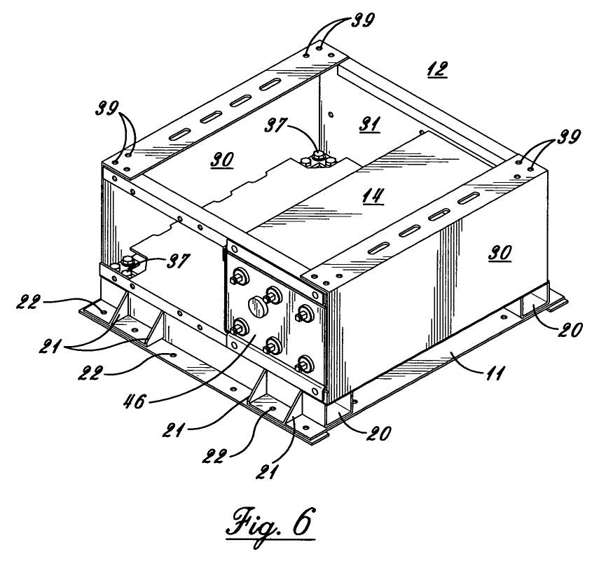

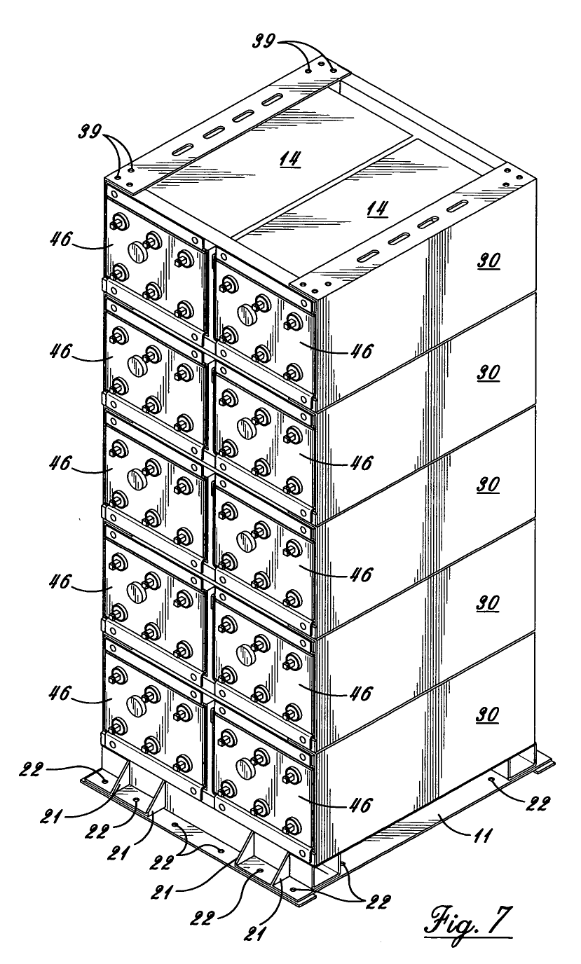

Preferring now more particularly to the drawings and FIGS. 1-7, the single cell module system 10 is illustrated therein. The system 10 includes a mounting base 11, a module 12, and a plurality of individual cell sleeves 14, to be described.

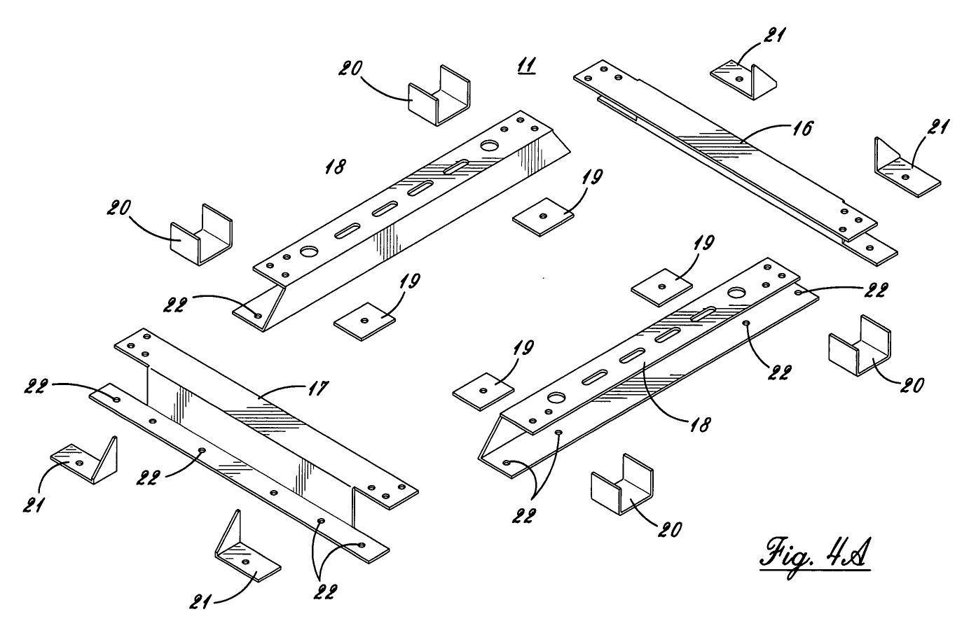

The mounting base 11 as shown in FIGS. 4 and 4A is of symmetric square configuration preferably constructed of metal stampings, with a rear channel 16, front channel 17, and connecting side channels 18, with support plates 19 under channels 18. The front and rear channels 17 and 16 are of open square configuration, and the side channels 18 include U-shaped plates 20, which reinforce the channels 18, and L-shaped plates 21 are provided for reinforcement of front and rear channels 17 and 16. The front channel 17, rear channel 16, and side channels 18 have openings 22 for bolting the base 11 to the floor (not shown).

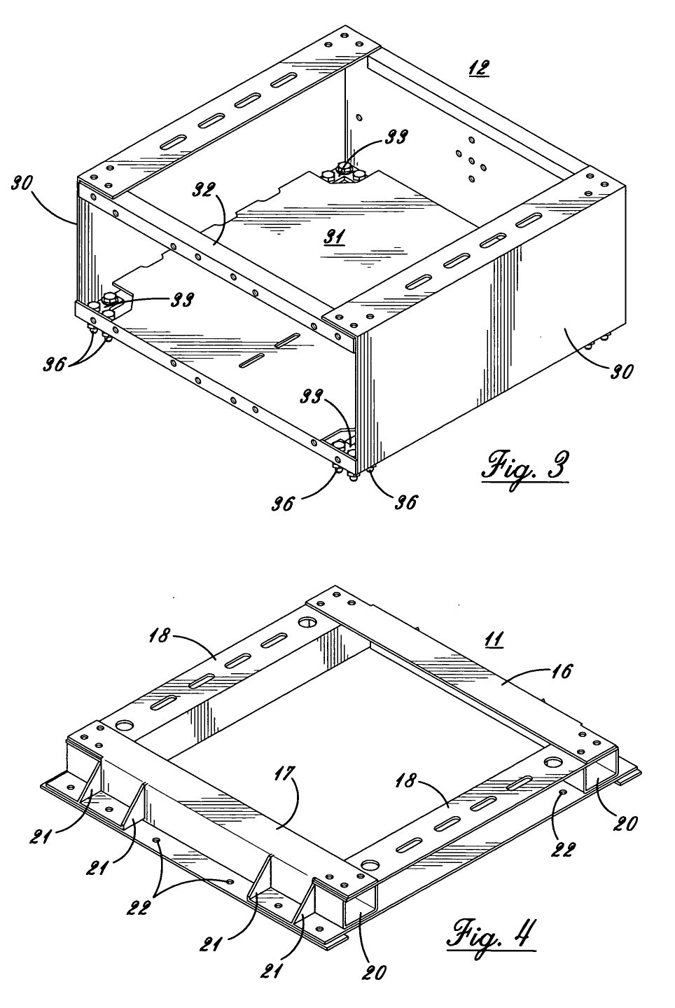

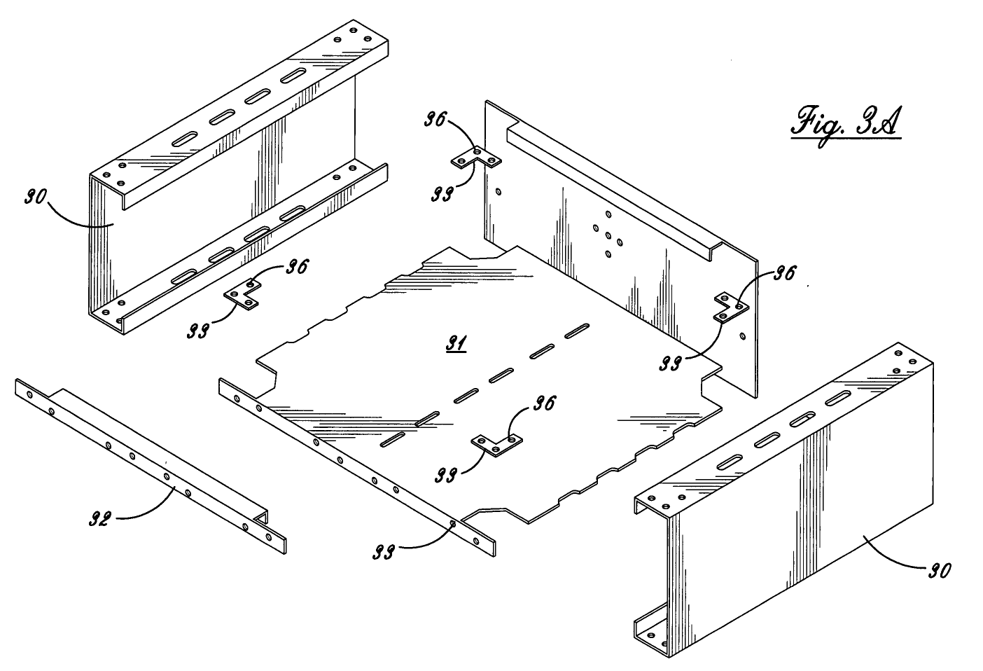

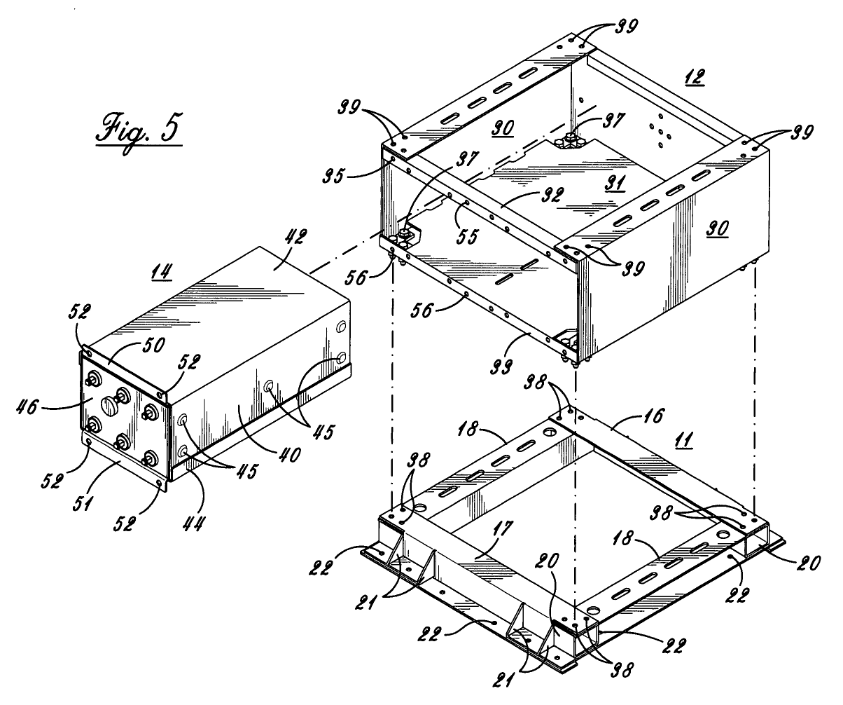

The module 12 as shown in FIGS. 3, 3A and 5 is of square configuration with C shaped side channels 30, a bottom back panel 31, with an upturned flange 33, and a front top channel 32 connected to the side channels 30. The module 12 in each corner is provided with L-shaped load plates 33, which each have weld nuts 36 thereon, with three bolts extending therethrough, which mate with openings 38 in base 11, and openings 39 in channels 30, which places the bolts 37 in tension and compression improving their performance during a seismic event.

The cell sleeves 14 are of rectangular configuration as seen in FIG. 1A with side plates 40, and top and bottom plates 42, and 43, with flanges 44. The side plates 40 are each provided with a plurality of buttons 45, which serve to space the sleeves 14 from the side channels 30 for airflow to provide cooling for the battery cell 46. The battery cells 46 are preferably of well known sealed lead acid type, carried in the sleeves 14, and spaced from the sleeves 14 by the buttons 45. The buttons 45 also improve the structural integrity of the side plates 40. The sleeves 14 are carried in module 12, and provided with upper and lower front flanges 50 and 51, to provide for fastening the sleeves 14 to the module 12 by bolts (not shown), extending through openings 52 in the front flanges 50 and 51, into openings 55 and 56 in the front channel 34, and upturned flange 33 of back bottom panel 31, to retain the sleeves 14 in module 12. The upper and lower flanges 50 and 51 also provide for lifting, installing and removing the cell sleeves 14 without contacting the battery cells 46 It will thus be seen that a single cell module system has been provided with which the objects of the invention are achieved.

I claim:

1. A single cell module system for storing battery cells, which comprises
a mounting base of square configuration,
said base having front and rear channels, and side channels connecting said front and rear channels,
said side channels having a top and bottom plate, spanning and connecting said front and rear channels,
U shaped plates at the intersection of said side channels, and said front and rear channels,
said front and rear channels having bracket means thereon for reinforcement and fastening to a floor,
at least one module of square configuration, with C shaped side channels, a rear panel, a bottom panel having an upturned panel, and a front channels connected to said side channels,
a load plate means in each corner of said module to connect it to said base, and to other modules,
at least one cell sleeve carried in said module, and open at the front to receive and retain a battery cell,
said cell sleeves are of rectangular configuration with side plates, and top and bottom plates connected together, and
said sleeve having upper and lower front flange means for lifting and removing said sleeve and fastening it to said module.

2. A single cell module system as defined in claim 1 in which, said reinforcement and fastening means includes L shaped reinforcing brackets, with openings therein for fastening the module to a floor.

3. A single cell module system as defined in claim 1 in which, said system components are metal stampings.

4. A single cell module system as defined in claim 1 in which, said cell sleeve side plates have buttons thereon to space said cells for airflow.
